(19) United States
(12) Patent Application Publication
(10) Pub. No.: US 2007/0137333 A1
(43) Pub. Date: Jun. 21, 2007

(54) BALL SCREW FOR MACHINE TOOLS

(76) Inventors: Alfred Geissler, Pfronten (DE); Robert Jung, Pfronten (DE)

Correspondence Address: THE MAXHAM FIRM, 9330 SCRANTON ROAD, SUITE 350, SAN DIEGO, CA, 92121, US

(21) Appl. No.: 11/559,343

(22) Filed: Nov. 13, 2006

(30) Foreign Application Priority Data
Nov. 15, 2005 (DE) 20 2005 017 823.3

(51) Int. Cl. F16H 27/02

(52) U.S. Cl. 74/89.23

(57) ABSTRACT

A ball screw for machine tools comprising a rotatably supported hollow threaded spindle, a drive unit for the threaded spindle, a nut provided on the threaded spindle so as to be longitudinally movable and a cooling system of the threaded spindle comprising a supply port and a discharge port for a cooling liquid flowing inside of the hollow threaded spindle. For obtaining an enhanced cooling performance with a reduced technical complexity a supply channel and a return channel communicating with it are provided in the cavity of the threaded spindle, and the supply port and the discharge port are provided at the same end of the threaded spindle.

### BACKGROUND

1. Field of the Invention

The invention relates generally to a ball screw for machine tools.

2. Background Discussion

Ball screws are, in particular, used in machine tools for translatively moving machine parts, for example, tables, slides, housings, or the like, in one of the coordinate axes. Since such machine parts frequently have considerable masses in modern machine tools, and are shifted over shorter or longer distances at high speeds, a relatively high driving power is required. Even though the overall friction losses are kept within limits by the recirculating balls, considerable heating of the spindle itself as well as the nut longitudinally moving on the spindle occurs in case of a high driving power. To avoid the disadvantages of such heating, modern ball screws may be provided with cooling systems in which usually a flow-through of a cooling liquid is established inside the cavity of the hollow threaded spindle formed as a continuous longitudinal bore. By metering the flow rates supplied to the spindle the efficiency of the desired cooling effect can be selected in accordance with the respective operating conditions and the temperatures of the spindle. A disadvantage of this known cooling system, however, is that on each end portion of the threaded spindle a cooling liquid port, including corresponding inlet and outlet lines, has to be provided. Therefore, not only the overall technical complexity is increased but the separate positioning of the inlet and outlet ports on respectively one end of the spindle also increases the space required and reduces the access to other machine parts.

### SUMMARY OF THE INVENTION

It is a purpose of the invention to provide an efficient ball screw for machine tools comprising a more advantageously positioned and technically simpler cooling system than previously known.

According to the invention, in a ball screw for machine tools the purpose is achieved by providing a supply channel and a return channel communicating with it in the cavity of the hollow threaded spindle. The supply port for the supply channel and the discharge port of the return channel are located at the same end of the threaded spindle.

By dividing the cavity of the hollow threaded spindle into a supply channel, preferably extending along the total length, and a return channel of the same length communicating with it, a reduplication of the overall channel length is obtained as compared to known cooling systems, which results in an increased cooling effect. Of particular importance is, however, the common location of the two ports, that is, the supply port and the discharge port, at one end of the threaded spindle. The complete liquid fittings receive a concentrated arrangement which is not only space-saving but also leads to a considerable simplification of the coolant line system.

Effectively the threaded spindle is provided, at its one end, with a closing member closing the cavity and at the same time serving as a support for one end of a pipe provided in the cavity of the threaded spindle. The pipe divides the cavity in a radially outer ring-shaped chamber and an inner cylindrical chamber, which chambers communicate with each other via connecting orifices provided in the end portion of the pipe. Respectively one cooling liquid port is provided in the outer ring-shaped chamber and in the inner chamber.

### BRIEF DESCRIPTION OF THE DRAWING

The objects, features, and advantages of the method according to the invention will be more clearly perceived from the following detailed description, when read in conjunction with the accompanying drawing, in which:

FIG. 1 shows a longitudinal cross section of a ball screw for machine tools in accordance with the invention;

FIG. 2 is an enlarged view of section X in FIG. 1; and

FIG. 3 is an enlarged view of section Y in FIG. 1.

### DETAILED DESCRIPTION OF THE PREFERRED EMBODIMENTS

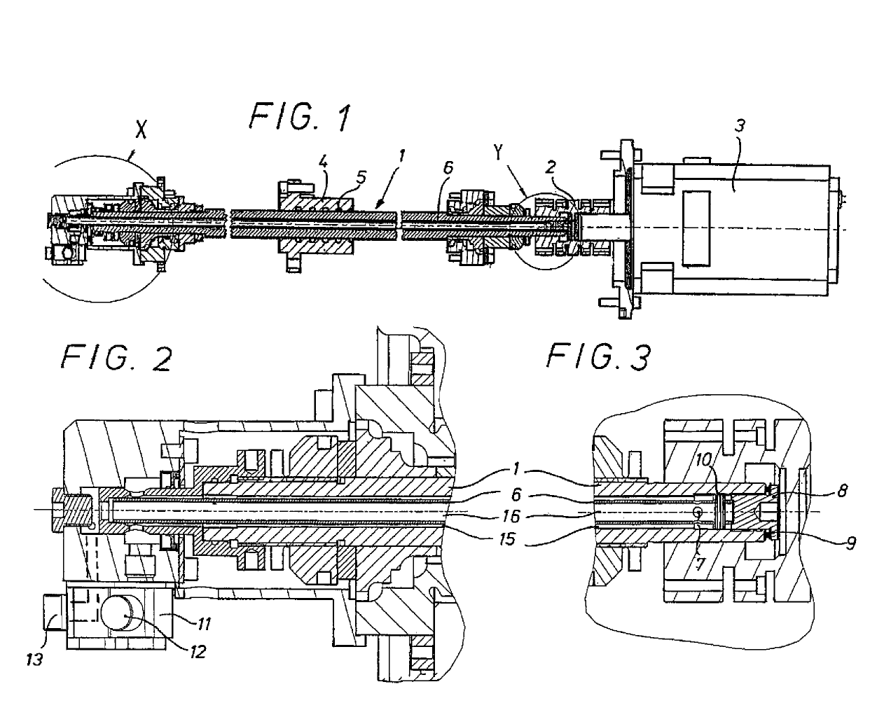

An embodiment of a ball screw in accordance with the invention comprises threaded spindle 1 connected, on the right end portion shown in FIG. 1, with drive unit 3 via coupling arrangement 2 in a torque-resistant manner. Drive unit 3 is usually an electric motor with or without an integrated gearbox. Nut 4 is arranged on spindle 1 so as to be longitudinally shiftable along a ball recirculation 5 attached to a component (not shown) of the machine tool and serving as a driver or driving member for moving the component in the longitudinal direction of the threaded spindle.

The so far conventional ball screw comprises a cooling system effecting an intense cooling of threaded spindle 1 along its entire length by means of a circulating cooling liquid. As can be seen in FIGS. 2 and 3, continuous pipe 6, provided with a plurality of connection orifices 7 in its rear end section, is disposed in the center of the continuous cylindrical cavity of spindle 1. The end of pipe 6 shown in FIG. 3 is fixed in a closing plug 8 introduced, for example, screwed, into the end portion of the threaded spindle and sealed by O-ring 9. In addition the end portion of pipe 6 is secured in threaded spindle 1 by transverse pin 10.

The portion of threaded spindle 1 and of pipe 6 mounted in its cavity shown in FIG. 2 includes fittings for supplying a cooling liquid into the divided cavity of the threaded spindle. In one fitting 11 two spigots 12, 13 are provided which are connected to supply and discharge lines (not shown) for the cooling liquid. Spigot 12 is in flow connection with radially outer ring-shaped space 15 of the cavity of the hollow threaded spindle. The outer ring-shaped space is connected to central inner space 16 of pipe 6 via the connecting orifices 7 shown in FIG. 3. Inner space 16 is connected to port 13 via channels shown in broken lines in FIG. 2. Outer ring-shaped space 15 may be referred to as a supply channel, and central inner space 16 may be referred to as a return channel.

For obtaining a particularly effective cooling of the complete spindle the cooling liquid is introduced into outer ring-shaped space 15 of spindle cavity 6 via port 11 with a predetermined pressure. The cooling liquid flows through ring-shaped space 15 along the entire length of the spindle and then via the end side orifices 7 into inner space 16 of pipe 6. The recirculated coolant is returned into the cooling system of the machine via the internal channels and outlet 13.

The invention is not limited to the embodiment shown. Thus, instead of a pipe 6, other means may be provided to divide the cavity of the hollow threaded spindle. By the specific arrangement and distribution of the flow orifices the liquid circulation may be influenced. The invention is to be limited only in accordance with the appended claims and reasonable equivalents.

What is claimed is:

1. A ball screw for machine tools comprising:
a rotatably supported hollow threaded spindle having an internal cavity;
a drive unit coupled to said threaded spindle;
a nut provided on said threaded spindle so as to be longitudinally movable with respect to said threaded spindle;
a cooling system of said threaded spindle, said cooling system comprising a supply port and a discharge port for a cooling liquid flowing inside of said hollow threaded spindle; and
a supply channel and a return channel communicating with said supply channel, said supply and return channels provided in the cavity of said hollow threaded spindle;
said supply port and said discharge port being provided at the same end of said threaded spindle.

2. The ball screw according to claim 1, wherein said hollow threaded spindle is provided with a closing member closing the cavity of said threaded spindle at one end.

3. The ball screw according to claim 1, and further comprising a pipe in the cavity of said threaded spindle, said pipe dividing the cavity into a radially outer ring-shaped chamber and an inner chamber.

4. The ball screw according to claim 2, and further comprising a pipe in the cavity of said threaded spindle, said pipe dividing the cavity into a radially outer ring-shaped chamber and an inner chamber.

5. The ball screw according to claim 4, wherein an end of said pipe is fixed in said closing member.

6. The ball screw according to claim 5, and further comprising connecting orifices in the end portion of said pipe.
